(19) United States
(12) Patent Application Publication
(10) Pub. No.: US 2026/0257320 A1
(43) Pub. Date: Sep. 3, 2026

(54) STRUT CHANNEL RATCHET AND METHOD THEREFOR

(71) Applicant: Francisco Rangel, Baytown, TX (US)

(72) Inventor: Francisco Rangel, Baytown, TX (US)

(21) Appl. No.: 19/067,001

(22) Filed: Feb. 28, 2025

(51) Int. Cl. B25B 13/46; B25G 1/06

(52) U.S. Cl. CPC B25B 13/466; B25G 1/063

(57) ABSTRACT

A strut channel ratchet includes a handle and a ratchet head is attached to an end of the handle. The strut channel socket is attached to the ratchet head. The strut channel socket includes a shaft and a socket head that is designed to engage a rotatable fastening structure. The socket head includes two rounded sides and two flattened sides. The socket head has a diameter between the flattened sides smaller than a diameter between the rounded sides such that the socket head is insertable into a strut channel through a slot between two legs of the strut channel with the flattened sides oriented parallel to the legs of the strut channel.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to ratchets and more particularly pertains to a new strut channel ratchet for tightening nuts and bolts located in a strut channel. Strut channels are used, for example, in electrical and plumbing installations to support wiring and pipes. Strut channels have two legs separated by slot, which slot is often narrower than the interior of the strut channel itself. As a result, strut channels can accommodate nuts and bolt heads that are equal to or larger in diameter than the slot. Unfortunately, such larger nuts and bolt heads which require a socket head that is larger than the slot. Specialized strut channel sockets can be used with reduced diameter heads. These are expensive and can be lost easily, especially when working at heights. The new strut channel ratchet incorporates a strut channel socket as a permanent part of the tool.

### (2) Description of Related Art Including Information Disclosed Under 37 CFR 1.97 and 1.98

The prior art relates to ratchets. The prior art, as best understood, does not disclose a strut channel ratchet that incorporates a strut channel socket as a permanent part of the tool attached to a ratchet head.

### (H) BRIEF SUMMARY OF THE INVENTION

An embodiment of the disclosure meets the needs presented above in a strut channel ratchet generally comprising a handle and a ratchet head is attached to an end of the handle. The strut channel socket is attached to the ratchet head. The strut channel socket includes a shaft and a socket head that is designed to engage a rotatable fastening structure. The socket head includes two rounded sides and two flattened sides. The socket head has a diameter between the flattened sides smaller than a diameter between the rounded sides such that the socket head is insertable into a strut channel through a slot between two legs of the strut channel with the flattened sides oriented parallel to the legs of the strut channel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a strut channel ratchet according to an embodiment of the disclosure.

FIG. 2 is a front view of an embodiment of the disclosure.

FIG. 3 is a side view of an embodiment of the disclosure.

FIG. 4 is a perspective view of an embodiment of the disclosure in use.

FIG. 5 is a perspective view of an alternative embodiment of the disclosure.

### (J) DETAILED DESCRIPTION OF THE INVENTION

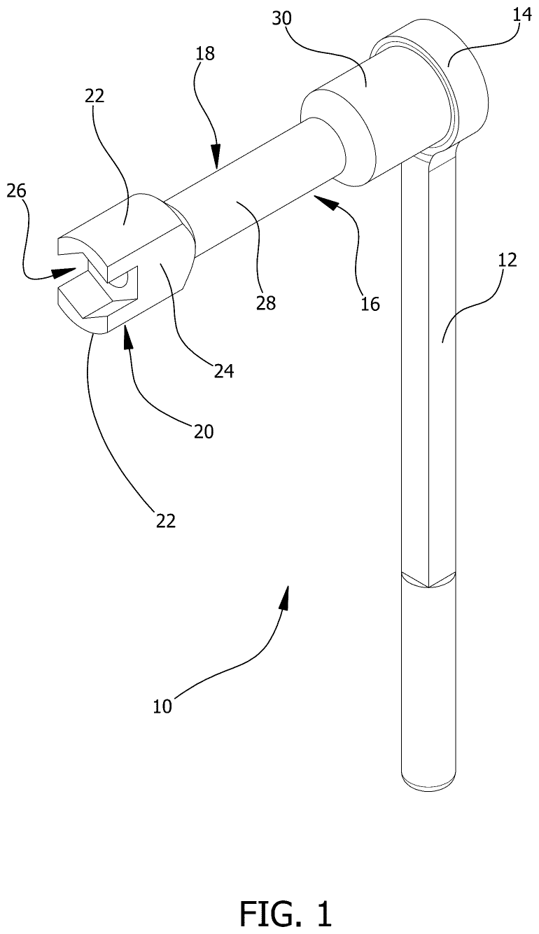

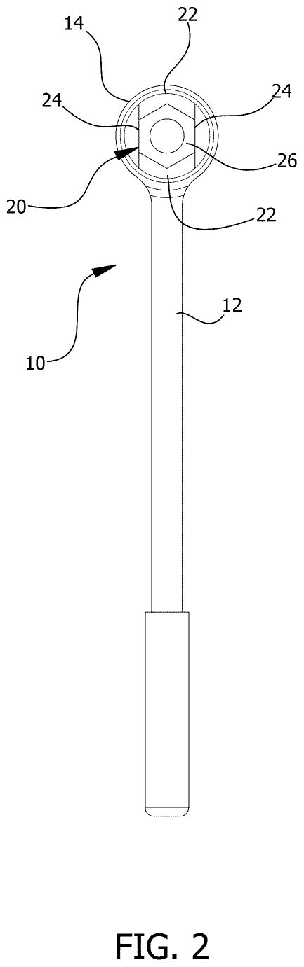

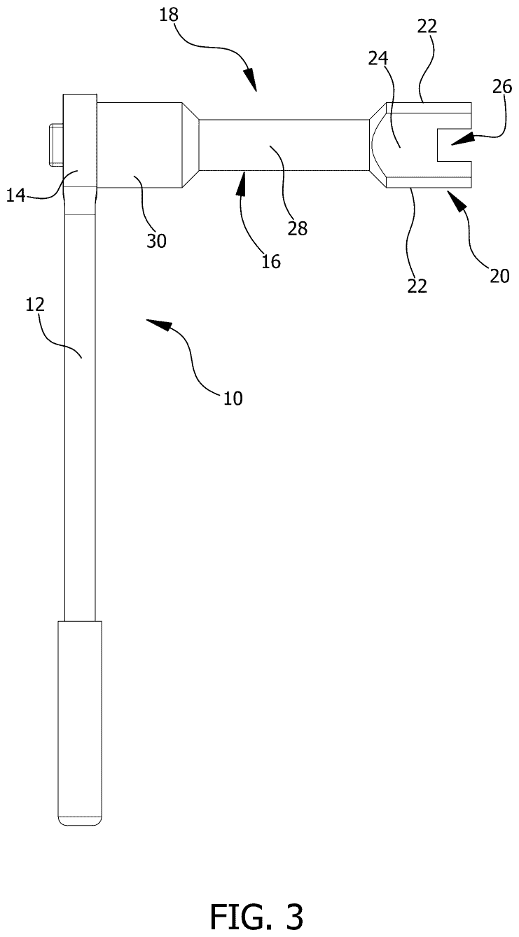

With reference now to the drawings, and in particular to FIGS. 1 through 5 thereof, a new strut channel ratchet embodying the principles and concepts of an embodiment of the disclosure and generally designated by the reference numeral 10 will be described.

As best illustrated in FIGS. 1 through 5, the strut channel ratchet 10 generally comprises a handle 12 and a ratchet head 14 is attached to an end of the handle 12. The strut channel socket 16 is attached to the ratchet head 14. The strut channel socket 16 includes a shaft 18 and a socket head 20 that is designed to engage a rotatable fastening structure 50. The socket head 20 includes two rounded sides 22 and two flattened sides 24. The socket head 20 has a diameter between the flattened sides 24 smaller than a diameter between the rounded sides 22 such that the socket head 20 is insertable into a strut channel 60 through a slot 62 between two legs 64 of the strut channel 60 with the flattened sides 24 oriented parallel to the legs 64 of the strut channel 60.

As mentioned, the shaft 18 is attached to the ratchet head 14. Users often must work in elevated areas, so, if the strut channel socket 16 becomes dislodged while working, it could be permanently lost or at least result in significant waste of time retrieving it. In one embodiment, the shaft 18 is welded to the ratchet head 14. In another possible embodiment, the shaft 18 is adhesively bonded to the ratchet head 14. In yet another possible embodiment, the shaft 18 is integrally formed with the ratchet head 14 as a one-piece structure.

The socket head 20 includes a receptacle 26. As shown in FIG. 1, the receptacle 26 is open-ended and hexagonal and designed to engage a hexagonal rotatable fastening structure 50, such as a nut, a bolt head, or a screw head. The receptacle 26 could possibly be square or octagonal as desired. The receptacle 26 does not necessarily need to be open-ended, but omission of material on the sides of the receptacle 26 narrows the socket head 20 for insertion through the slot 62 in the strut channel 60, so maximum removal of such material is advantageous and does not hinder the ability of the socket head 20 to engage nuts, bolt heads, and screw heads.

In the exemplary embodiment, the shaft 18 includes a body portion 28 integrally formed with the socket head 20 and a base portion 30 attached to the ratchet head 14. The base portion 30 of the shaft 18 has a larger diameter than the body portion 28 of the shaft 18. However, in another possible embodiment, the base portion 30 could be omitted and the body portion 28 of the shaft 18 could be directly attached to or integrally formed with the ratchet head 14.

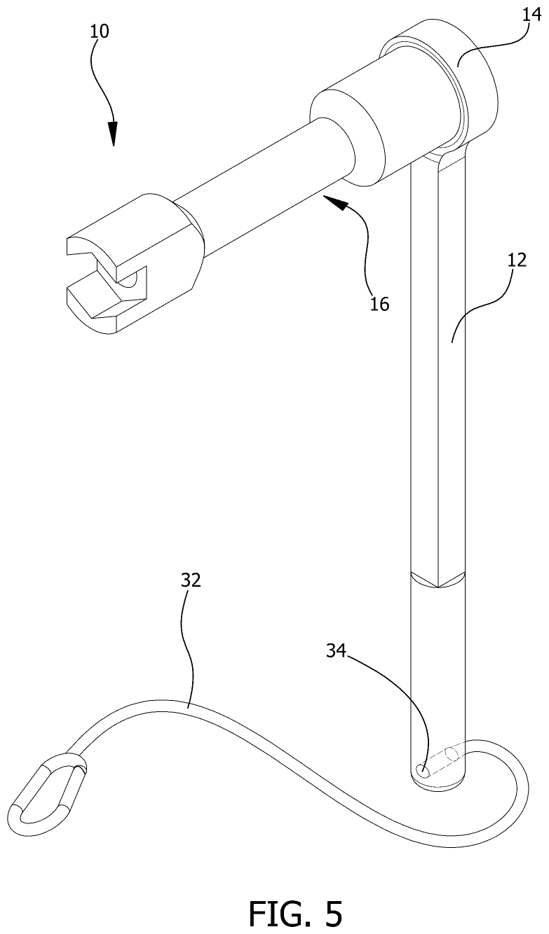

In the alternative embodiment shown in FIG. 5, the strut channel ratchet 10 further includes a tether 32 attached to the handle 12. The tether 32 could be secured to the clothing of the user to avoid loss of or damage to the strut channel ratchet 10 if dropped. In the exemplary embodiment in FIG. 5, the handle 12 includes an aperture 34 therein to which the tether 32 is connected.

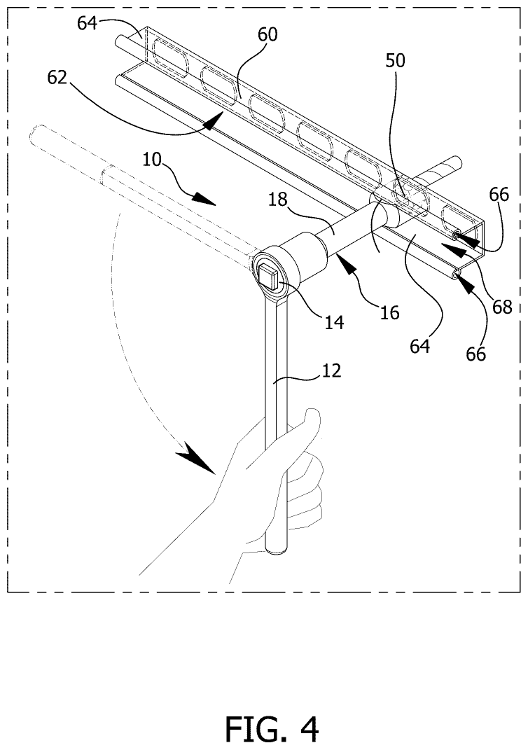

FIG. 4 shows how the strut channel ratchet 10 could be used to engage the rotatable fastening structure 50, in this case a hexagonal bolt, in the strut channel 60. The user inserts the socket head 20 into the strut channel 60 through the slot 62 between the two legs 64 of the strut channel 60 with the flattened sides 24 oriented parallel to the legs 64 of the strut channel 60. As shown in FIG. 4, each of the legs 64 has a lip 66 projecting inwardly, which makes the width of the slot 62 smaller than the width of a channel space 68 between the legs 64. As a result, the socket head 20 must be oriented in this manner or the socket head 20 will not fit through the slot 62. Once the socket head 20 is inserted, the user engages the rotatable fastening structure 50 with the socket head 20, and then rotates and tightens the rotatable fastening structure 50 by pivoting the handle 12 back and forth in the manner common to ratchet tools. The socket head 20 is free to rotate in the larger channel space 68, while the body of the shaft 18, which has a smaller diameter than the widest portion of the socket head 20, can rotate in the slot 62 of the strut channel 60. In addition, since the strut channel socket 16 is attached to the ratchet head 14, the user can selectively strike the strut channel 60 with the strut channel socket 16 to selectively level the strut channel 60 as desired. The user then does not need to bring or use a separate tool, such as a hammer, to level the strut channel 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A strut channel ratchet comprising:
a handle;
a ratchet head being attached to an end of said handle; and
a strut channel socket being attached to said ratchet head, said strut channel socket including a shaft and a socket head being configured to engage a rotatable fastening structure, said socket head including two rounded sides and two flattened sides, said socket head having a diameter between said flattened sides smaller than a diameter between said rounded sides such that said socket head is insertable into a strut channel through a slot between two legs of the strut channel with said flattened sides oriented parallel to the legs of the strut channel.

2. The strut channel ratchet of claim 1, wherein said shaft is welded to said ratchet head.

3. The strut channel ratchet of claim 1, wherein said shaft is adhesively bonded to said ratchet head.

4. The strut channel ratchet of claim 1, wherein said shaft is integrally formed with said ratchet head as a one-piece structure.

5. The strut channel ratchet of claim 1, wherein:
said socket head includes a receptacle; and
said receptacle is open-ended and hexagonal and configured to engage a hexagonal rotatable fastening structure being one of: a nut, a bolt head, and a screw head.

6. The strut channel ratchet of claim 1, wherein:
said shaft includes a body portion integrally formed with said socket head and a base portion attached to said ratchet head; and
said base portion of said shaft has a larger diameter than said body portion of said shaft.

7. The strut channel ratchet of claim 2, wherein:
said socket head includes a receptacle; and
said receptacle is open-ended and hexagonal and configured to engage a hexagonal rotatable fastening structure being one of: a nut, a bolt head, and a screw head.

8. The strut channel ratchet of claim 7, wherein:
said shaft includes a body portion integrally formed with said socket head and a base portion attached to said ratchet head; and
said base portion of said shaft has a larger diameter than said body portion of said shaft.

9. The strut channel ratchet of claim 3, wherein:
said socket head includes a receptacle; and
said receptacle is open-ended and hexagonal and configured to engage a hexagonal rotatable fastening structure being one of: a nut, a bolt head, and a screw head.

10. The strut channel ratchet of claim 9, wherein:
said shaft includes a body portion integrally formed with said socket head and a base portion attached to said ratchet head; and
said base portion of said shaft has a larger diameter than said body portion of said shaft.

11. The strut channel ratchet of claim 4, wherein:
said socket head includes a receptacle; and
said receptacle is open-ended and hexagonal and configured to engage a hexagonal rotatable fastening structure being one of: a nut, a bolt head, and a screw head.

12. The strut channel ratchet of claim 4, wherein:
said shaft includes a body portion integrally formed with said socket head and a base portion attached to said ratchet head; and
said base portion of said shaft has a larger diameter than said body portion of said shaft.

13. The strut channel ratchet of claim 1, further comprising a tether attached to said handle.

14. The strut channel ratchet of claim 8, further comprising a tether attached to said handle.

15. A method of engaging a rotatable fastening structure in a strut channel, said method comprising the steps of:
providing a strut channel ratchet comprising:
a handle;
a ratchet head being attached to an end of said handle; and
a strut channel socket being attached to said ratchet head, said strut channel socket including a shaft and a socket head being configured to engage a rotatable fastening structure, said socket head including two rounded sides and two flattened sides, said socket head having a diameter between said flattened sides smaller than a diameter between said rounded sides such that said socket head is insertable into a strut channel through a slot between two legs of the strut channel with said flattened sides oriented parallel to the legs of the strut channel;
inserting said socket head into a strut channel through a slot between two legs of the strut channel with said flattened sides oriented parallel to the legs of the strut channel;
engaging a rotatable fastening structure with said socket head;
rotating and tightening said rotatable fastening structure; and
selectively striking the strut channel with said strut channel socket to selectively level the strut channel.
